(19) United States
(12) Patent Application Publication
(10) Pub. No.: US 2018/0084085 A1
(43) Pub. Date: Mar. 22, 2018

(54) CROSS PLATFORM DEVICE VIRTUALIZATION FOR AN IOT SYSTEM

(71) Applicant: Arrayent, Inc., Redwood City, CA (US)

(72) Inventors: Karthik Shanmugasundaram, San Jose, CA (US); Shane E. Dyer, San Francisco, CA (US); Jarrod Sinclair, San Jose, CA (US); Glenn Seidman, Woodside, CA (US); Cyril Brignone, San Francisco, CA (US)

(73) Assignee: Arrayent, Inc., Redwood City, CA (US)

(21) Appl. No.: 15/270,361

(22) Filed: Sep. 20, 2016

(51) Int. Cl. H04L 29/06; H04L 12/46; H04L 29/08

(52) U.S. Cl. CPC H04L 67/42; H04L 67/025; H04L 12/4641

(57) ABSTRACT

Methods and systems disclosed herein utilize virtual native technology to allow for the fluid interoperability of incompatible Internet of Things (IOT) cloud platforms and the services and devices administrated thereby. Virtual native technology allows a platform to function just as if the virtual native devices it serves were native to the platform. Virtual native devices and services are treated by their host platforms just like devices that are specifically designed for those platforms. Thereby, the complexity of network interoperability for the devices is pushed permanently into the upfront development of an adapter and server that can communicate with another cloud via their specific APIs, while the platform can focus on facilitating the functional interoperability of the devices required by end users and the applications developers working to fulfill those requirements.

### BACKGROUND OF THE INVENTION

FIG. 1 illustrates an internet of things (IOT) system 100. The system includes a customer site 101 with at least two IOT devices. Customer site 101 can be a home, office building, or any area where a user utilizes IOT devices in combination. Customer site 101 includes a first IOT device 102 and a second IOT device 103. As illustrated, the devices are a smart light 102 and a security system 103 that a user will want to use in combination.

A user might want to configure IOT system 100 such that when an alert is sent by security system 103, smart light 102 turns on automatically. Total interoperability and configurability of these separate devices is the goal of the IOT industry. However, the IOT industry has been the subject of intense fragmentation. As such, it is common for first IOT device 102 and second IOT device 103 to each be administrated via separate and incompatible clouds 104 and 105, respectively. An incompatible cloud is one that has its own data structures, event handling procedures, or object models such that instructions meant for execution on a separate cloud cannot be executed by the software components of the incompatible cloud without modification, or data meant for storage on a separate cloud cannot be stored by the software components of the incompatible cloud without modification. The clouds will each offer their own platform of services 106 and 107 for administrating the devices that are native to the cloud and for analyzing the data provided by those devices. However, these services will not be able to directly access the data from devices that are native to other clouds or directly provide commands to those devices. The IOT devices can receive information directly from other devices and provide information all the way up to the applications layer of their respective clouds, but only within their network.

In order to provide interoperability among these incompatible clouds, cloud administrators offer API layers 108 to allow other clouds to access information on their own native IOT devices and to send commands to those IOT devices. For example, API 108 might allow cloud 104 to periodically poll security system 103 via platform 107 to check if the security system has issued an alert. However, the administrator of cloud 104 will still need to write custom software 109 to interface with API 108 and translate the information received from API 108 for platform 106.

### SUMMARY OF THE INVENTION

Approaches disclosed herein include an internet of things (IOT) system that utilizes virtual native technology. The system comprises a cloud server located in a first data center and a first IOT device located at a customer site. The first IOT device communicates with the cloud server via the Internet. The system also comprises a first data representation of the first IOT device administrated by the cloud server. The system also comprises a virtual native server. The system also comprises a second IOT device located at the customer site. The second IOT device communicates with the cloud server via the Internet, an API, the virtual native server, and a second cloud server. The system also comprises a second data representation of the second IOT device administrated by the virtual native server. The system also comprises a first cloud adapter instantiated on the virtual native server. The first cloud adapter enforces consistency between the second IOT device and the second data representation of the second IOT device. A first instruction executed by the cloud server pulls information from the first IOT device or pushes commands to the first IOT device. A second instruction executed by the cloud server pulls information from the second IOT device or pushes commands to the second IOT device. The first instruction and the second instruction share a compatible syntax.

Approaches disclosed herein include another internet of things (IOT) system that utilizes virtual native technology. The system comprises a cloud server located in a first data center and a first IOT device located at a customer site. The first IOT device communicates with the cloud server via the Internet. The system also comprises a first data representation of the first IOT device administrated by the cloud server. The system also comprises a virtual native server. The system also comprises a second IOT device located at the customer site. The second IOT device communicates with the cloud server via the Internet, an API, the virtual native server, and a second cloud server. The system also comprises a second data representation of the second IOT device administrated by the virtual native server. The system also comprises a first cloud adapter instantiated on the virtual native server. The first cloud adapter enforces consistency between the second IOT device and the second data representation of the second IOT device. The system also comprises an access token for the second cloud server stored in a memory by the virtual native server. The first cloud adapter enforces consistency between the second IOT device and the second data representation of the second IOT device by reading data from the second device via the API and the second cloud server; and writing data to the second device via the second cloud server. The first cloud adapter enforces consistency between the second IOT device and the second data representation of the second IOT device using the access token.

Approaches disclosed herein include another internet of things (IOT) system that utilizes virtual native technology. The system comprises a cloud server located in a first data center and a first IOT device located at a customer site. The first IOT device communicates with the cloud server via the Internet. The system also comprises a first data representation of the first IOT device administrated by the cloud server. The system also comprises a virtual native server located in the first data center. The system also comprises a second IOT device located at the customer site. The second IOT device communicates with the cloud server via the Internet, the virtual native server, and a second cloud server. The system also comprises a second data representation of the second IOT device administrated by the virtual native server. The system also comprises a first cloud adapter instantiated on the virtual native server. The first cloud adapter enforces consistency between the second IOT device and the second data representation of the second IOT device. The cloud server includes stored instructions to do least one of the following actions: (i) directly issue every command the second IOT device can receive; and (ii) read every data entry collected by the second IOT device.

### BRIEF DESCRIPTION OF THE DRAWINGS

FIG. 1 illustrates a block diagram of an IOT system that uses custom software and APIs to provide compatibility between IOT devices that are administrated by incompatible cloud platforms in accordance with the related art.

FIG. 2 illustrates a block diagram of an IOT system that uses virtual native technology to provide compatibility between IOT devices that are administrated by incompatible cloud platforms in accordance with embodiments described in the present disclosure.

FIG. 3 illustrates a block diagram of an IOT system with cloud adapters in accordance with the virtual native technology of FIG. 2.

FIG. 4 illustrates a flow chart for a set of methods for federating devices in an IOT system that is in accordance with embodiments described in the present disclosure.

FIG. 5 illustrates a cloud adapter architecture that can be modified to operate in combination with the system of FIG. 3.

FIG. 6 illustrates a block diagram to describe a set of methods for a data object implementation of the virtual native technology of FIG. 2.

FIG. 7 illustrates a block diagram to describe a set of methods for a queue-based implementation of the virtual native technology of FIG. 2.

### DETAILED DESCRIPTION OF THE EMBODIMENTS

Reference now will be made in detail to embodiments of the disclosed invention, one or more examples of which are illustrated in the accompanying drawings. Each example is provided by way of explanation of the present technology, not as a limitation of the present technology. In fact, it will be apparent to those skilled in the art that modifications and variations can be made in the present technology without departing from the scope thereof. For instance, features illustrated or described as part of one embodiment may be used with another embodiment to yield a still further embodiment. Thus, it is intended that the present subject matter covers all such modifications and variations within the scope of the appended claims and their equivalents.

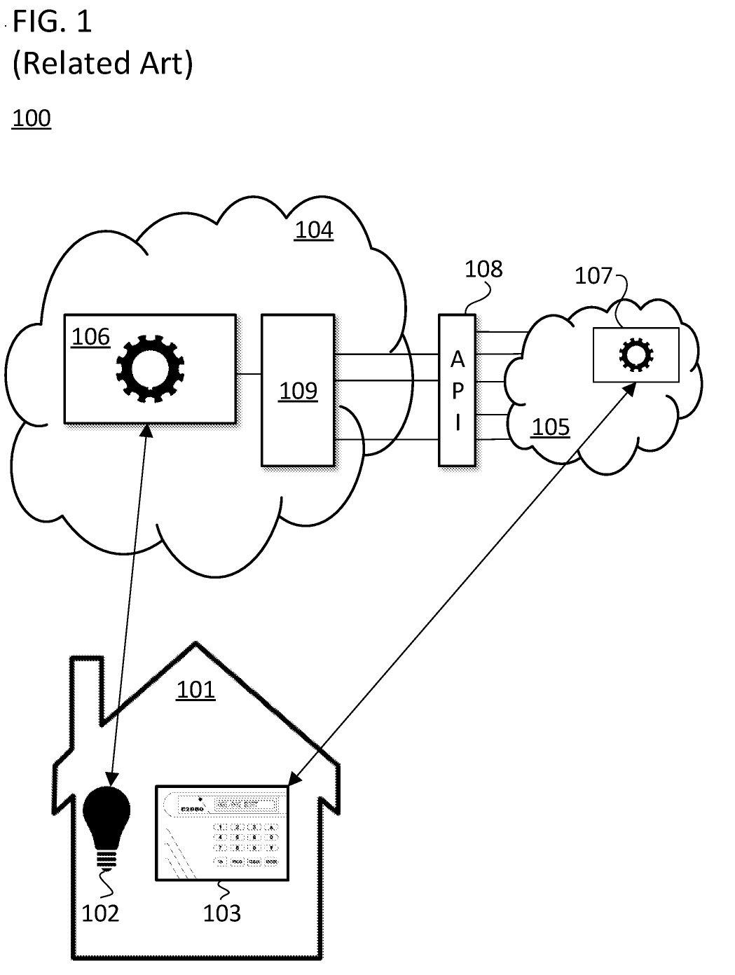

The system of FIG. 1 allows for interoperability for IOT devices that are native to incompatible clouds, but it is far from the idealized vision of a fluid interconnected network of disparate devices. The custom software 109 illustrated in FIG. 1 allows platform 106 to provide commands to, or receive information from, device 103 by utilizing APIs 108. However, similar custom software would need to be written for each potential type of interoperability desired by the end users. If the user suddenly decided that they want light 102 to come on any time the device 103 detects motion rather than anytime device 103 detects a break in, the custom software 109 will need to be updated to include code to obtain this information from the device 103 via APIs 108. Furthermore, if the user decides to swap out the device 103 with a second device administrated by another cloud, custom software 109 could potentially be useless as the second device would not be accessed via API 108.

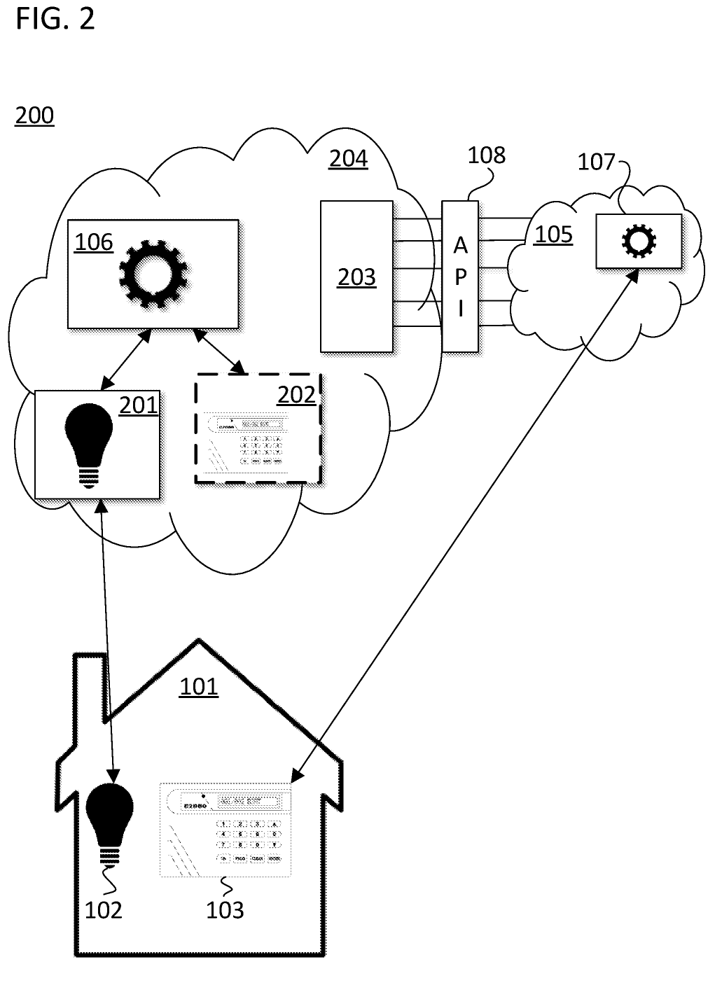

FIG. 2 illustrates a block diagram of an IOT system 200 that uses virtual native technology to provide compatibility between IOT devices that are administrated by incompatible cloud platforms. The devices can be consumer products that have IOT functionality such as a smart thermostat or alarm with functionality or data that can be utilized or accessed via the Internet. The devices can also be an Internet accessible service such as email or SMS instantiated on a server located in a data center. IOT system 200 still includes customer site 101 and devices 102 and 103 administrated by incompatible clouds 204 and 105. However, virtual native technology allows platform 106 to function just as if devices 102 and 103 were both native to cloud 204. This is done by making second device 103 a virtual native device on cloud 204. Cloud 204 can be a version of cloud 104 augmented with virtual native technology. Virtual native devices are treated by their host platforms just like devices that are specifically designed for those platforms. Thereby, the complexity of network interoperability for the devices is pushed permanently into the upfront development of an adapter and server that can communicate with another cloud via their specific APIs, while platform 106 can focus on facilitating the functional interoperability of the devices required by end users and the applications developers working to fulfill those requirements.

Virtual native technology allows for the disassociation of the work needed to ensure compatibility between clouds and the actual implementation of interconnected usage cases for the devices administrated by those clouds. As conceptually illustrated in FIG. 2, virtual native server 203 creates a data representation of a virtual native device 202 within cloud 204. A virtual native server is a web server that is native to a first cloud, is capable of communicating with a separate cloud via API calls to that cloud, can collect information regarding devices administrated by that incompatible cloud using those API calls, and can send commands to those devices using those API calls. As in FIG. 1, device 102 and device 103 are native to incompatible clouds and are likely manufactured and designed by separate companies. However, the data representation of a virtual native device 202 is of substantially the same format and syntax as the data representation of a native device 201. Using that data representation, a cloud platform, which can be identical to cloud platform 106 from FIG. 1, can operate upon the data representation of virtual native device 202 and the data representation of the native device 201 in exactly the same manner.

As opposed to the system of FIG. 1, the functionality of system 200 can be quickly expanded to account for additional user requirements. If additional functionality is required for the interoperability of devices 102 and 103, instructions can be produced for platform 106 to execute without regard to the underlying incompatibility between platform 204 and cloud 105. As such, a first instruction executed by the cloud server that instantiates cloud platform 106 and which pulls information from the first IOT device or pushes commands to the first IOT device 102 could share a compatible syntax with a second instruction executed by the cloud server which pulls information from the second IOT device 103 or pushes commands to the second IOT device. A compatible syntax is one which would be commonly understood by a subset of software elements in a network. For example, all of the software elements on cloud 105 could be able to understand and execute instructions with a compatible syntax. As another example, the rules engine, web APIs, analytics engine, and data storage component of a cloud platform would all be able to understand and execute instructions with a compatible syntax. The compatible syntax could also be an identical syntax. As another example, a rules engine could be instantiated by the cloud server to provide a layer of abstraction for users of the platform to define rules as to how devices administrated by the platform would interact or react to their environment. The rules engine could be used to formulate the first instruction and the second instruction with the compatible or identical syntax mentioned above. In other words, the rules engine would have full access to the device just as if they were both native to the platform.

Virtual native devices are first class citizens of the cloud platforms to which they have been aligned. Therefore, if an IOT device has been naturalized to a cloud platform using virtual native technology, the cloud platform will have full access to the capabilities of the IOT device and the information provided by the IOT device. The cloud server can therefore include stored instructions to directly issue every command that the IOT device can receive. The cloud server could also include instructions to read every data entry collected by the IOT device. The cloud server would have the same level of control and access to the virtual device as it would to any other device on the native network. Once the second IOT device has been naturalized, the cloud server will include stored instructions to directly issue every command the second IOT device can receive and/or read every data entry collected by the second IOT device.

As illustrated, device 102 has an object representation in cloud 204 represented by object 201. This object representation can be a data representation of device 102 stored in memory according to a set of attributes and key value pairs. The key can be an ID of the device. The object representation could alternatively be a queue based representation where the state of the device could be extrapolated from entries stored temporarily in a queue upon which cloud server platform 106 was operating. At the same time, device 103 has an object representation in cloud 204 represented by object 202 even though device 103 is a virtual native of cloud 204, and not a true native of cloud 204 like device 102. The rules engine could be embedded in the cloud server or it could run as a separate component outside of the cloud server. The rules associated with incompatible clouds can be created, read, updated or deleted through REST APIs. The rules are persisted in a database. The schema of the database can be designed to support multi-tenant capability.

The object representation of device 103 can be the exact same kind of data representation as for device 102. All that will need to change is the device type and set of attributes due to the differing physical characteristics of devices 102 and 103.

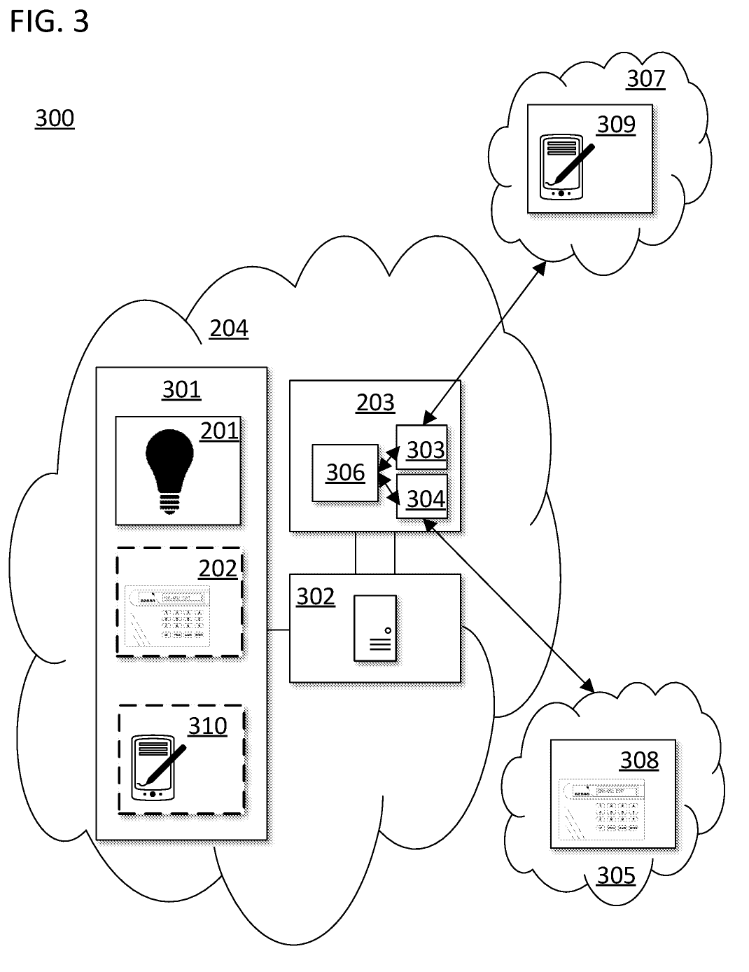

As mentioned previously, utilizing virtual native technology, device 103 is treated as a first class citizen of platform 106 such that device 103 virtually lives on the network administrated by cloud 204. As used in the specification first class citizen refers to the degree to which the virtual device can interact with the high level services offered by platform 106. In short, a first class citizen interacts with these high level services to the same degree as a device that was specifically designed to operate with those services by virtue of understanding the internal function calls and normalized data structures of cloud 106. Virtual native technology is provided by cloud connectors and cloud adapters that are instantiated in virtual native server 203. The virtual native server 203 operates alongside the cloud server that instantiates the cloud platform 106. Virtual native server 203 enforces a contract between cloud 204 and cloud 105. Essentially, virtual native server 203 enforces data and state synchronization between a representation of device 103, in the form of virtual native device 202, and device 103 itself. A more specific breakdown of this functionality is provided by system diagram 300 in FIG. 3.

System diagram 300 is based around cloud 204. The cloud includes cloud server 302, database 301, and virtual native server 203. As will be described below, cloud server 302 instantiates native device 201 in memory 301 and also works in combination with virtual native server 203 to instantiate virtual native device 202 as an object in memory to represent a virtual native device that is compatible with the cloud platform of cloud 204. Memory 301 can be implemented as a dedicated key-value pair database, or a queue-based system such as a Kafka queue. Virtual native server 203 includes two cloud adapters 303 and 304. These adapters allow for communication between separate and incompatible clouds 305 and 307 respectively to allow devices that are native to those clouds to be instantiated as virtual devices in memory 301. The adapters work to enforce a contract between the incompatible clouds and cloud 204. Enforcement of the contract assures that the data for virtual native devices remains up to date and that commands provided to those devices are actually implemented. For example, enforcement of the contract could involve updating the values stored for the properties or attributes of object 202, and issuing commands to object 202 and the actual device represented by object 202.

Cloud adapters 303 and 304 can enforce contracts by providing set and get attributes from the incompatible clouds 307 and 305, respectively, as well as subscriptions to events sourced from those clouds. The cloud adapters could be used to enforce consistency between devices on incompatible platforms and the data representations of those devices administrated by cloud server 302 and virtual native server 203. As illustrated, this could involve assuring that the state of data representation 202 was kept in synchronization with a data representation of the device stored on an incompatible cloud 308.

A specific cloud adapter can be created for each cloud for which interoperability and compatibility is required. However, each cloud adapter will only need to be created once and can be formed from a generic cloud adapter with slight modifications for the APIs offered and file structure used by the cloud to which it is designed for. As illustrated, cloud server 302 enforces consistency between the representation of native device 201 and a first IOT device itself while first cloud adapter 304 is needed to enforce consistency between a second IOT device and the second data representation of the second IOT device 202 by reading data from the second device via APIs offered by a second cloud server on cloud 305 and writing data to the second device via the second cloud server on cloud 305. Consistency requires that the data representation is kept up to date with the state of the physical device as it changes due to its own internal control functions and exogenous factors as well as by issuing commands to the physical device to change its state that are commensurately reflected in the data representation. In some cases, both the command and its effect can be logged at the same time. However, in other cases the command will be logged and the response to the command will be logged in the form of data from the physical device.

Cloud adapters 304 and 303 both represent the entire incompatible cloud to cloud 204 as well as handling all user accounts and their associated devices. Communication between virtual native server 203 and the incompatible clouds can be conducted via REST streaming, REST APIs, asynchronous protocols, stream protocols, publication and subscription based protocols, call back protocols, and any API generally. The approaches to retrieve data from incompatible clouds can be grouped in two categories—pull approaches or push approaches. In a pull approach, data can be read from an incompatible cloud by calling an API. The cloud adapters can be configured to read the data from the incompatible clouds in the configured intervals. In some use approaches, the APIs are invoked every time when a particular code block is executed by the cloud platform. In push approaches, various methods are available to maintain synchronization and enforce consistency contracts. In publish/subscribe or PubSub approaches, the adapters or users subscribe to topics offered by the compatible clouds. When data is published to the topic, the cloud adapters read and process the data. The subscription could be user specific or user agnostic based. In streaming approaches, the data is streamed from incompatible clouds through channels such as firebase. The channels are user specific or user agnostic.

Communication between the virtual native server 203 and cloud server 302 can be conducted via web service APIs generally offered by cloud server 302. In other approaches, the communication can be conducted in an alternative fashion such as via a REST service or other API service. The adapters can be created as micro services that do not maintain state. If a particular adapter instance is handling a heavy load, a new machine for that adapter can be spun up quickly.

Virtual native servers, such as virtual native server 203, can also include cloud connectors, such as cloud connector 306. The cloud connectors ensure synchronization of device attributes across all clouds. A cloud connector is a server based callable container that can maintain a map of an attribute path in one cloud with the specific attribute path it corresponds to in all other clouds that it is to be associated with. Thus, if a cloud connector has N associated cloud adapters, then each map entry will have N attribute paths. When any one of the attributes in any one of the associated clouds updates, the cloud connector is called back and sets the associated attributes in the other clouds simultaneously. The cloud connector therefore facilitates the enforcement of consistency not only between cloud 204 and a single cloud, but across all clouds for which compatible functionality is desired by users of the platform offered by cloud 204.

The action of a cloud connector, such as cloud connector 306, can be described with reference to FIG. 3. In FIG. 3, a third IOT device located at a customer site could be in communication with a third cloud and be represented by a data representation 309 administrated by a cloud server on cloud 307. The third IOT device could communicate with cloud server 302 via the Internet, a second API, the third cloud server on cloud 307 and the virtual native server 203. Second cloud adapter 303 would then allow a third representation of this third IOT device 310 to be administrated by virtual native server 203. Second cloud adapter 303 would then enforce consistency between the third IOT device and the third representation of the third IOT device 310.

With the introduction of two virtual native devices to cloud 204 from two different incompatible clouds, the utility of cloud connector 306 becomes even more apparent. As illustrated, cloud connector 306 can receive a common command from cloud server 302 and provide a first translated command to the first cloud adapter 304 and a second translated command to the second cloud adapter 303. The first and second translated commands would be translated versions of the common command. For example, the command could be a request for power consumption information from every device administrated by a common account, or a general “turn on” command sent out to all devices when a user enters the customer site. The translation of the common command by the cloud connector 306 could be conducted in part using an attribute path map stored by the cloud connector 306. As a result, cloud server 302 is isolated from having to configure commands for the attribute or property paths while the cloud adapters are in turn able to be easily configured from a generic adapter framework to focus on handling commands and data requests for a specific cloud architecture.

The attribute path map could include paths for specific attributes as they are stored in the file structures of the various clouds. For example, the status of a light as on or off could be stored in the file structure of one cloud according to the path: userID/deviceID/status/power, while the data for the same attributed could be stored in the file structure of another cloud according to the path: region/devicelD/properties/state. The attribute path map could translate requests to read or write to these various properties according to the stored paths. For example, the attribute path map could include a first path for the attribute in a first data structure of the second cloud 305 and a second path for the attribute in a second data structure of the third cloud 307. The attribute path map could be a set of key value pairs stored in data on the virtual native server and administrated by the cloud connector. The attribute could be the key to this set of key value pairs. In keeping with the prior example, the key could be a value for the “power state” attribute of the data representations of the device while the paths were the values of those key value pairs. The key would be set by the manner in which cloud server 302 represented the various IOT devices that are compatible with its platform.

The virtual native servers, such as virtual native server 203, can also store a local cache of federated tokens. The provisioning of federated tokens is described in more detail below. The schema of federated tokens could be a user id key with columns associated with each of the clouds for which an access token is stored. The user id can be a user id for cloud 204. A federated( )call to a cloud adapter, such as an API call, performs the initial population of a field called accessToken in the constituent field of the federated tokens schema.

Virtual native server 203 and the virtual native technology it provides are an improvement over prior approaches. In the first instance, they are less susceptible to requiring rework due to a user opting to switch out an old device for a new different device that is incompatible with the current platform. This is because, rather than writing brand new custom software out of whole cloth for the entire transition, all that needs to be updated are the cloud connectors while the cloud adapters can remain the same. Additionally, the technology is less susceptible to requiring rework when a new device that provides novel processing technology is introduced in an incompatible cloud. This is because, again rather than coding everything from scratch, only the cloud adapters will need to be updated. Therefore, although more work up front may be required to produce the code and infrastructure for virtual native server 203, once the code is developed, it is much easier to adapt to changing circumstances or an expansion of the network. In addition, users of the cloud platform are able to use devices on incompatible clouds just as if the device was a native device connected to a cloud they are familiar with operating. This provides a significant benefit to the users as it is easier to implement interactions between their devices, and simplifies the mental model of their personal network of IOT devices which they would otherwise need to maintain when administrating that network.

The cloud adapters can be classified into different categories. Cloud adapters can include device adapters, hub adapters, and IOT integration platform provider adapters. A device adapter is one that is meant to allow for synchronization with a cloud platform that is used to administrate a set of branded devices. For example, the cloud platform may be used to administrate thermostats and smoke alarms in accordance with a proprietary standard protocol and methodology. A hub adapter is one that is meant to allow for synchronization with a cloud platform that is used to administrate hubs for IOT functionality. For example, the cloud platform may be used to administrate hubs at individual customer sites that interact with numerous IOT devices at the site. This is important because hubs can be considered a specialized type of device. Hubs can collect information from and deliver commands to multiple IOT devices and can deliver information between the devices. The hubs also sometimes administrate their own separate network for doing so. For example, the hub could administrate a network or IOT devices in a home in parallel with a home Wi-Fi network. However, a hub can have its own functionality added on top of its duties as a simple network administrator such that it is much more feature rich than a router or other piece of networking equipment. As such, maintaining a model of the hub on a cloud platform can be particularly valuable. An IOT integration platform provider adapter is one that is meant to allow for synchronization with a cloud platform that provides a high level IOT service or application. For example, the cloud platform could enable a user to define actions that can be taken using IOT devices or cloud applications in response to certain events detected using IOT devices or cloud applications.

Device adapters can be further characterized by device type. The virtual native server can have access to stored definitions for several device types such as thermostats, smoke alarms, cameras, and other IOT devices. The stored definitions can comprise different attributes that describe the device and its state. For example, the attributes could include global attributes (version number, manufacturer, country code, etc.), hardware attributes (device capabilities, device status, etc.), and other attributes. The attributes can have values of numerous types such as string, JSON, XML, number, Boolean, binary, enum, etc. Global attributes will be static across a given manufacturing line. Hardware attributes may vary and their manipulation and reading will allow the platform to control the device and get the status of other devices. The other attributes category will include attributes that could not be classified in the hardware or global attributes category such as the metadata of the devices.

Hub adapters will be similar to the device adapters but will include additional information to account for the hub placed between the platform and the device. For example, the attributes of a hub adapter may include a hub id and device list that includes a list of devices connected to the hub. The hub adapter can then be used to control and monitor the IOT devices connected to the hub.

The device types recognized by the cloud server of a given platform, such as web server 302, do not need to change except for the addition of a new device type for virtualized devices. The procedure for producing these additional device types is the same as for introducing a new native device. The same web service APIs that work with native devices will work with these new virtual device types.

The lifecycle of a device that is brought into the service of a cloud platform from an incompatible cloud can be described with reference to a series of four steps. The first step is federation. During federation, an incompatible cloud hands over access to a device or set of devices which are associated with a user account on that incompatible cloud. The second step is claiming in which the attributes of that device are pulled in to the virtual native system and are categorized and processed to assure compatibility with the cloud platform. The third step is synchronization which includes all of the contract enforcement executed by the virtual native server to assure that the data representation of the device administrated by the cloud platform matches the actual state of the device. The final step is defederation in which access to the devices is abandoned by the cloud platform and any access credentials used to access those devices are deleted.

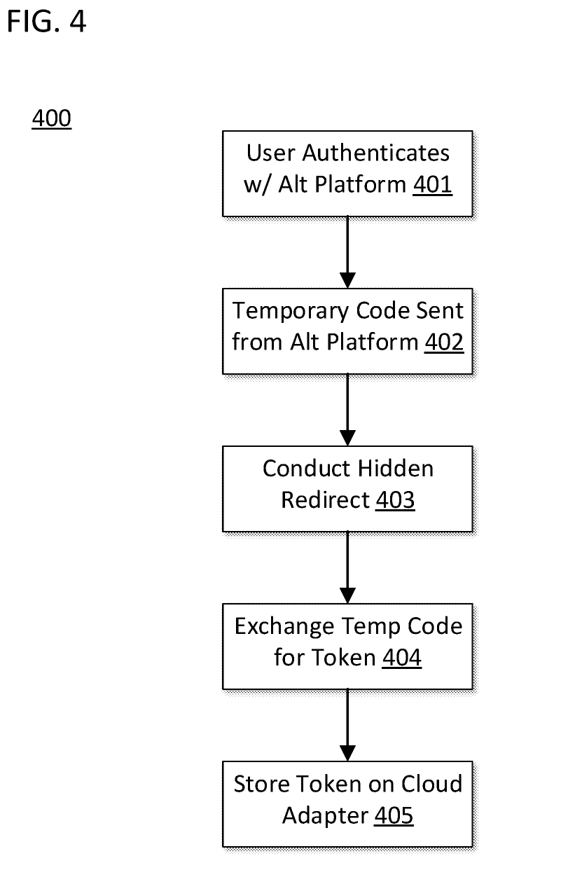

FIG. 4 provides a flow chart 400 for a set of methods for federating devices on alternative platforms. Flow chart 400 begins with step 401 in which a user authenticates with an alternative platform. In step 402, a temporary code is sent from the alternative platform to cloud 204. In step 403, a hidden redirect occurs on cloud 204 which provides the temporary code to the cloud adapter. In step 404, the cloud adapter provides the temporary code to the incompatible cloud using a REST API to perform the federation and retrieve a device ID for the federated device. This step also involves retrieving the accessToken, which is provided in exchange for the temporary code. In step 405, the data is stored by a cloud adapter on the container instantiating the cloud adapter and is not transmitted to the user. Step 404 can be conducted using a REST API on cloud server 302 to obtain an accessToken to be used in subsequent calls to that platform. For example, the accessToken could be retrieved from the platform's OAuth 2 authentication API.

Virtual native server may support multi-tenant and multi-environment capabilities based on the customer use case, the data model can be created specific for a customer or be customer agnostic. Virtual native server 203 can be structured such that a user of cloud server 302 on cloud 204 can be associated with multiple incompatible clouds, and can also be associated with multiple potential devices and multiple potential users in those incompatible clouds. In other words, there does not have to be a one-to-one mapping between users of the platform offered by cloud 204 and users in an alternative incompatible cloud such as 305. As such, one user that needs to control multiple user accounts on a single incompatible platform, such as their own accounts and their spouse's account, will be able to do so. Additionally, multiple users on cloud 204 can be linked to a single device on an incompatible platform. In other words, the federation and device management process allows one-to-one, many-to-one, one-to-many, and many-to-many mapping. In the case of multiple users on cloud 204 being provided access, the multiple users can be given limited access to the additional devices. For example, they may be able to obtain data from a device, but not provide it with commands. However, the multiple users can also each be given full access to the device. Also, the mapping can account for devices operating in multiple environments such as development, staging, and production.

The federation process links a user of cloud 204 with the user account from incompatible clouds. The process of linking can be done is various ways based on the authorization process for those clouds. For example, linking can be done via Oauth 1 and 2 calls, through use of username/password credentials, through the use of an API key, or via customer authorization. Once the authorization process is successful, the user can be identified by a unique user identifier such as a user id, access_token, API key, etc. The unique user identifier is then linked with an environment id so that cloud 204 can specifically identify the user account across multiple incompatible clouds. The generic adapter framework used to connect the accounts by cloud connector 306 and the cloud adapters has a separate key-space. For each cloud, a separate table can be created in a database accessible to virtual native server 203 with stored access tokens. If the cloud supports more than one authentication scheme, then multiple tables may be created to link the accounts.

Once a user federation is completed with an alternative and incompatible cloud, the devices from the cloud are accessible for cloud server 302 through the cloud adapter created for that specific cloud. However, the read and write operations may be restricted based on access control in the alternative cloud. In other words, access that is not provided to a device in its native platform is still generally denied when the device is a virtual native in an alternative platform. In that case, the authorization process may determine the level of access control for cloud server 302 to perform the read and write operations on the alternative cloud.

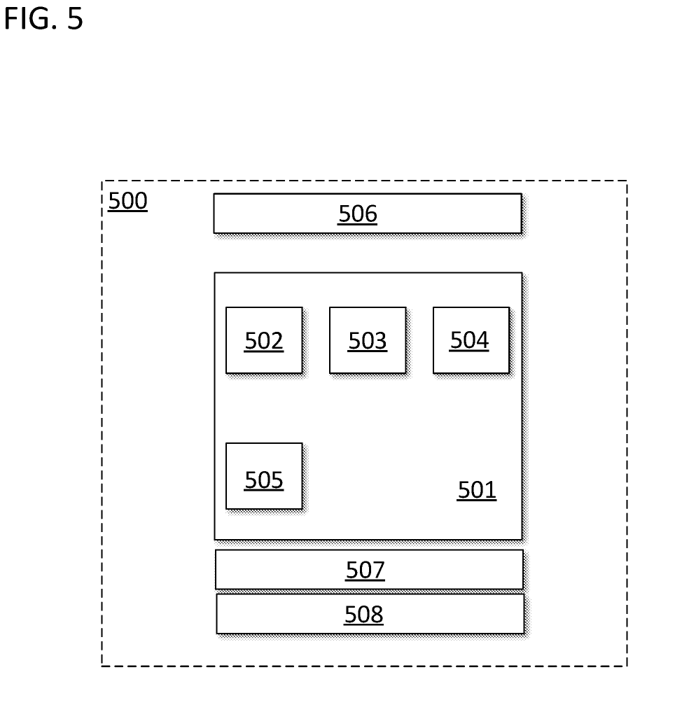

FIG. 5 illustrates a block diagram of a cloud adapter 500. The cloud adapter includes a common core 501. The cloud adapters are built on top of a generic adapter framework. The generic adapter framework, or common core, contains the common functionalities and code that are shared by all cloud adapters. There will be a different adapter for each incompatible cloud that users of cloud 204 want to obtain access to. There will only be one multi-tenant and multi-environment adapter for all of the users of cloud 204. All the adapters will extend the abstract adapter defined in the generic adapter framework. The common core can be shared by cloud adapters after they have been modified to be compatible for a specific cloud. For example, cloud adapters 303 and 304 could each share common core 501. Common core 501 includes an authorization module 502, a write to device module 503, and a read from device module 504. The modules can all comprise instructions stored in non-transitory computer readable media. The authorization module can be used by the cloud adapter to federate devices and user accounts from the incompatible clouds. The read from device module 504 and the write to device module 503 are generalized to handle any form of data transfer between IOT devices or between an IOT device and the cloud server. The authorization module 502 could be a custom auth module, an OAuth1 client, or an OAuth2 client. The OAuth2 and OAuth 1 components abstract the OAuth1 and OAuth2 connection logic to help develop the adapters faster.

The common core can also include additional modules represented by module 505. The additional modules could be selected from a set of modules that are likely to be required across various adapter types. For example, the additional modules could include a JSON Adapter, an Abstract Adapter, a REST Wrapper, Polling hooks, REST hooks, utility modules, or federation REST APIs. The additional modules may also include additional or substitute authorization or read modules. For example, the JSON adapter could be a substitute read module, and the OAuth1 client could serve as the authorization module 502 while an additional authorization module was also included in the common core. The Abstract adapter allows the generic adapters to speak to external software components by abstracting data from the various APIs to an internal proprietary format. The abstract adapter helps normalize that data and can be extended in the specific adapters. The JSON adapter can translate API responses from incompatible clouds that are not in JSON format to JSON before the data from the response is provided to the abstract adapter.

More details regarding these modules reveal how the common core can easily and quickly be adapted. The selection of modules is meant to keep the common core simple while still providing useful modules for a large number of incompatible cloud architectures. An Abstract Federation API module can support federation of user accounts and device/hub data as described above with reference to FIG. 4. The adapter can extend this functionality based on the needs of a particular platform. Polling/REST hooks modules can be used when users integrate their devices with IOT integration platforms and the cloud platform has to expose the APIs for changes in device/hub data. In the case of polling, the IOT integration platform providers can poll the data for the devices/hubs. The abstraction of such API is implemented in this component. It can be extended in the adapter's implementation. In the case of REST hooks, polling consumes lot of resources (CPU and memory), due to that any changes in device/hub data can be propagated to the subscribed clients in real-time. Examples for these clients are mobile apps built to function in combination with the cloud or general IOT integration platforms. The REST wrapper module is used to convert converting device/hub specific data to the normalized data so that is can be abstracted. The module also provides wrappers for REST APIs of all the devices/hubs enabled by the cloud to reduce the time of creation integration adapters. The Custom Auth module can include an OAuth1, username and password, and other custom authorization implementations to be abstracted. A utility module can include utilities required for building various adapters to augment the common core.

The device adapter 500 can then be expanded from its common core to function with a specific cloud server and provide compatibility with an alternative incompatible cloud platform. A utility module can be used to facilitate this process. The device adapter could include a data model adapter 507 to allow for administration of the data representation of devices that they naturalize. For example, data model adapter 507 could be a Kafka client if the data representation of the virtual native devices were implemented using a Kafka queue. The device adapter could also include a REST client 506 and a cloud specific adapter 508 to provide for compatibility between a particular incompatible cloud and the cloud server.

In situations where the cloud includes a rules engine. The rule engine interface is abstracted in the common core adapter, so that the adapters inherit access. The common core of the adapter may utilize the rule engine for executing the rule. However, the customized adapter itself could include the rules and not depend on a rules engine.

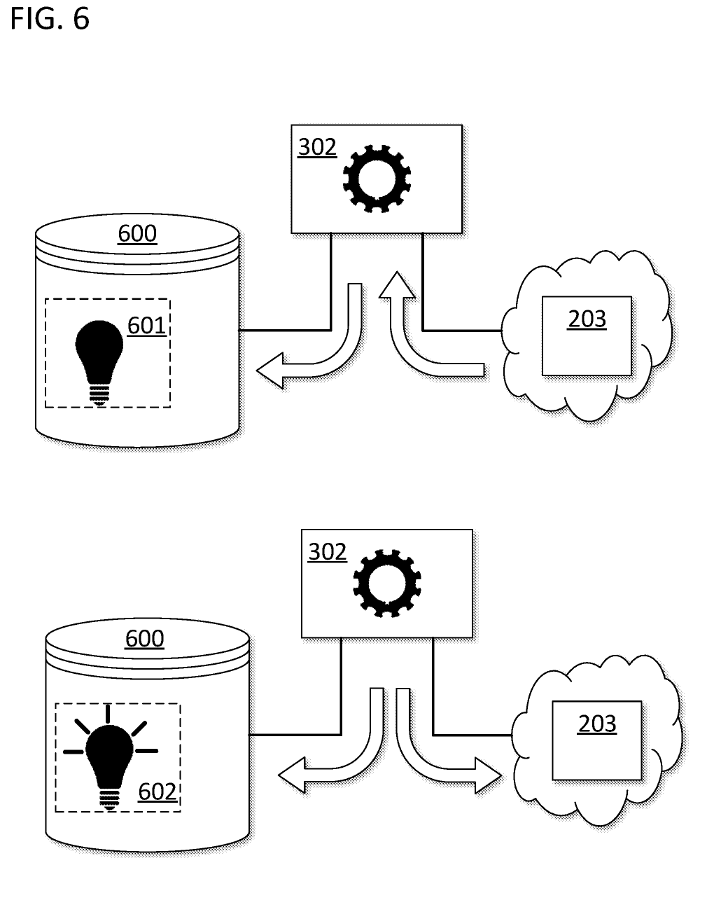

As mentioned previously, memory 301 can be a dedicated database used to store the attributes and properties of a representation of the devices in the network along with the values for those attributes and properties. As shown in FIG. 6, a database 600 could store a data representation of a virtual native device 601. Virtual native server 203 could then receive information regarding a change in the state of the device represented by representation 601 and transmit this information to cloud server 302 which would in turn update the representation of virtual native device 601. Alternatively, cloud server 302 could issue a command to change the state of the device which would be send to database 600 to alter the data representation to a new state represented by data representation 602 while the same command was provided to cloud adapter 203 to actually influence a commensurate change in the physical device.

Once object 202 or another data model is created on cloud 204, every instance of the device represented by that object 202 can be instantiated on cloud 204 using a separate object during the federation process. For example, data representations 201 and 202 could be data structures in that database where data representation 201 is created as soon as the associated device is on-boarded to the platform and data representation 202 is created as soon as the associated device is federated from an incompatible cloud. The data supporting the data model in the form of attributes can then be synchronized with third party devices via the enforcement of contracts as described above. However, in an alternative approach, devices are virtualized without creating an object 202 or data model for the device on cloud 204. Instead, the device data could be handled in real time for executing rules and operations upon that data using a queue-based approach.

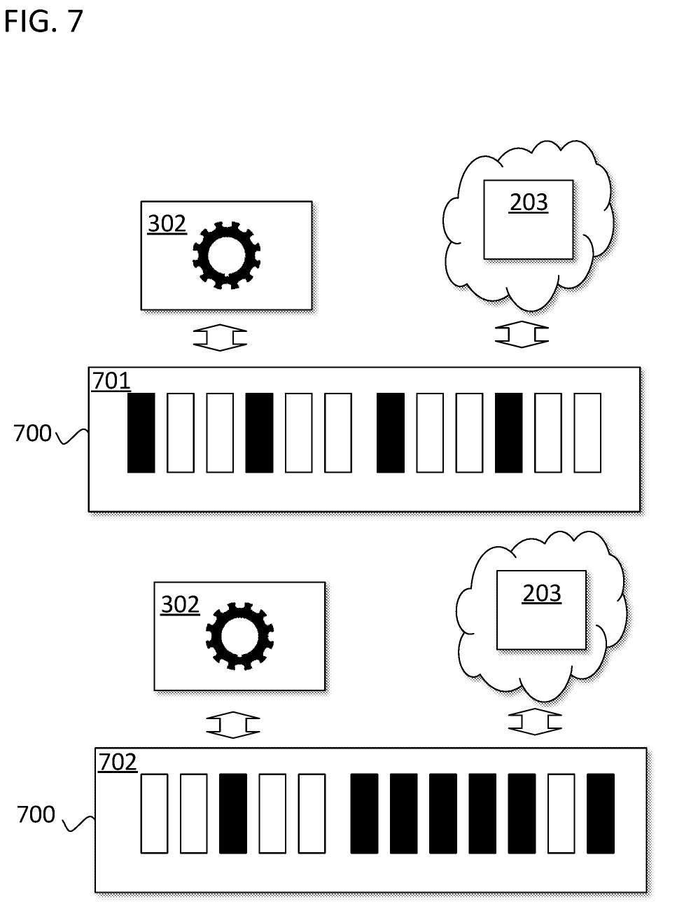

FIG. 7 illustrates a queue-based approach in which a queue 700 is instantiated on a cloud server. In a queue-based implementation, linear scalability can be achieved without any overhead. If the queue is not used, load balancers may need to be used to distribute the load. In the illustrated examples, the entries in the queue are black and white to indicate data associated with different devices as received by virtual native server 203. In queue state 701, the distribution of data is predictable and repetitive between the two topics. However, in queue state 702, a higher concentration of entries have been received for a specific device. In this case, the queue-based implementation achieves linear scalability without the need for load balancing because resources are inherently distributed via the ordering or the queue.

The cloud server could be cloud server 302 implemented by hardware located in a first data center. The memory 301 could then include the queue such that the data representations 202 and 310 were a set of entries in the queue. The queue could serve as the storage for events received from the adapters. The queue could also act as intermediary storage for synchronization by storing data from the incompatible clouds and analyzing deltas in the data to detect changes. Some incompatible clouds may send the whole state of a user account even if only a single attribute has been changed which makes analyzing the data to detect a delta essential for the functioning of an efficient synchronization system.

Each cloud adapter could queue data in a separate queue. These separate queues could be created using Kafka topics where each adapter reserved a topic to manage the events received via the adapter. The cloud adapters could then read from the topics that corresponding to them. In situations where the cloud includes a rule engine, the rule engine reads data from the queue and executes the rules changes to the device could be written to a specific topic reserved for a rule engine of the cloud. In such an implementation, the execution of a rule could cause the result of that rule's execution to be written to the corresponding rule engine topic. The common core of adapter the adapter framework shown in FIG. 4 could implement the interface for connecting to the queue (e.g., additional module 505 could be a Kafka queue module). The generic adapter framework implements the interface for connecting to the queue.

The link between an alternative cloud and the native platform can be severed when it is no longer needed through a process called defederation. The process can be conducted when a user no longer retains an account with the alternative platform. The process involves severing the link between the user account from the cloud server and the alternative platform. The authentication tokens or other credentials for the alternative platform will be marked for deletion on the cloud adapter and cloud connectors. However, before the tokens or credentials are removed, they may be used to complete the defederation process via final API calls to the alternative platform. During this process, any rules created by the user will be deleted or marked for deletion based on the configuration of the alternative platform. Also, device defederation may be conducted so that data for virtual devices stored by the native platform will be deleted or marked for deletion.

While the specification has been described in detail with respect to specific embodiments of the invention, it will be appreciated that those skilled in the art, upon attaining an understanding of the foregoing, may readily conceive of alterations to, variations of, and equivalents to these embodiments. The various databases and servers mentioned in the specification could be instantiated by hardware in the same datacenter or in alternative datacenters at disparate locations. Although reference has been made to devices being at the same site, devices located at separate customer sites and also benefit from the technologies disclosed herein as people often desire IOT interoperability to extend beyond a single physical location. In situations where the servers host incompatible platforms the servers would likely be in separate datacenters but may not be as different companies may utilize the same datacenter by leasing the services of a third company. Any of the method steps discussed above can be conducted by a processor operating with a computer-readable non-transitory medium storing instructions for those method steps. The computer-readable medium may be memory within an electronic device itself or a network accessible memory. These and other modifications and variations to the present invention may be practiced by those skilled in the art, without departing from the scope of the present invention, which is more particularly set forth in the appended claims.

What is claimed is:

1. An internet of things (IOT) system comprising:
a cloud server located in a first data center;
a first IOT device located at a customer site, wherein the first IOT device communicates with the cloud server via the Internet;
a first data representation of the first IOT device administrated by the cloud server;
a virtual native server;
a second IOT device, wherein the second IOT device communicates with the cloud server via the Internet, an API, the virtual native server, and a second cloud server;
a second data representation of the second IOT device administrated by the virtual native server; and
a first cloud adapter instantiated on the virtual native server, wherein the first cloud adapter enforces consistency between the second IOT device and the second data representation of the second IOT device;
wherein a first instruction executed by the cloud server pulls information from the first IOT device or pushes commands to the first IOT device;
wherein a second instruction executed by the cloud server pulls information from the second IOT device or pushes commands to the second IOT device; and
wherein the first instruction and the second instruction share a compatible syntax.

2. The IOT system of claim 1, further comprising:
a third IOT device, wherein the third IOT device communicates with the cloud server via the Internet, a second API, the virtual native server, and a third cloud server;
a third representation of the third IOT device administrated by the virtual native server;
a second cloud adapter instantiated on the virtual native server, wherein the second cloud adapter enforces consistency between the third IOT device and the third representation of the third IOT device; and
a cloud connector instantiated on the virtual native server;
wherein the cloud connector receives a common command from the cloud server, provides a first translated command to the first cloud adapter, and provides a second translated command to the second cloud adapter; and
wherein the first translated command and the second translated command are translated versions of the common command.

3. The IOT system of claim 1, wherein:
the compatible syntax is an identical syntax.

4. The IOT system of claim 2, further comprising:
an attribute path map for an attribute,
wherein the first and second cloud adapters are both required to enforce consistency with regards to the attribute;
wherein the attribute path map includes a first path for the attribute in a first data structure of the second cloud server;
wherein the attribute path map includes a second path for the attribute in a second data structure of the third cloud server;
wherein the attribute path map is a set of key value pairs stored in data on the virtual native server and administrated by the cloud connector; and
wherein the attribute is a key of the set of key value pairs.

5. The IOT system of claim 2, wherein:
the first cloud adapter and the second cloud adapter share a common core; and
the common core includes an authorization module, a write to device module; and a read from device module.

6. The IOT system of claim 5, wherein:
the first cloud adapter uses the authorization module and the second cloud server to federate the second IOT device; and
the second cloud adapter uses the authorization module and the third cloud server to federate the third IOT device.

7. The IOT system of claim 5, further comprising:
a database administrated by the cloud server;
wherein the first data representation of the first IOT device is a first data structure in the database; and
wherein the second data representation of the second IOT device is a second data structure in the database.

8. The IOT system of claim 5, further comprising:
a queue instantiated on the cloud server;
wherein the second data representation of the second IOT device is a set of entries in the queue.

9. The IOT system of claim 5, further comprising:
a rules engine instantiated on the cloud server;
wherein the rules engine formulates the first instruction and the second instruction in accordance with a rule.

10. An internet of things (IOT) system comprising:
a cloud server located in a first data center;
a first IOT device located at a customer site, wherein the first IOT device communicates with the cloud server via the Internet;
a first data representation of the first IOT device administrated by the cloud server;
a virtual native server;
a second IOT device, wherein the second IOT device communicates with the cloud server via a second cloud server, the Internet, an API, and the virtual native server;
a second data representation of the second IOT device administrated by the virtual native server;
a first cloud adapter instantiated on the virtual native server, wherein the first cloud adapter enforces consistency between the second IOT device and the second data representation of the second IOT device; and
an access token for the second cloud server stored in a memory by the virtual native server;
wherein the first cloud adapter enforces consistency between the second IOT device and the second data representation of the second IOT device by: (i) reading data from the second device via the API and the second cloud server; and (ii) writing data to the second device via the second cloud server; and
wherein the first cloud adapter enforces consistency between the second IOT device and the second data representation of the second IOT device using the access token.

11. The IOT system of claim 10, further comprising:
a third IOT device, wherein the third IOT device communicates with the cloud server via the Internet, a second API, the virtual native server, and a third cloud server;
a third representation of the third IOT device administrated by the virtual native server;
a second cloud adapter instantiated on the virtual native server, wherein the second cloud adapter enforces consistency between the third IOT device and the third representation of the third IOT device; and
a cloud connector instantiated on the virtual native server;
wherein the cloud connector receives a common command from the cloud server, provides a first translated command to the first cloud adapter, and provides a second translated command to the second cloud adapter; and
wherein the first translated command and the second translated command are translated versions of the common command.

12. The IOT system of claim 11, further comprising:
an attribute path map for an attribute,
wherein the first and second cloud adapters are both required to enforce consistency with regards to the attribute;
wherein the attribute path map includes a first path for the attribute in a first data structure of the second cloud server;
wherein the attribute path map includes a second path for the attribute in a second data structure of the third cloud server;
wherein the attribute path map is a set of key value pairs stored in data on the virtual native server and administrated by the cloud connector; and
wherein the attribute is a key of the set of key value pairs.

13. The IOT system of claim 11, wherein:
the first cloud adapter and the second cloud adapter share a common core; and
the common core includes an authorization module, a write to device module; and a read from device module.

14. The IOT system of claim 13, wherein:
the first cloud adapter uses the authorization module and the second cloud server to federate the second IOT device; and
the second cloud adapter uses the authorization module and the third cloud server to federate the third IOT device.

15. The IOT system of claim 11, further comprising:
a database located in the first data center and administrated by the cloud server;
wherein the first data representation of the first IOT device is a first data structure in the database; and
wherein the second data representation of the second IOT device is a second data structure in the database.

16. The IOT system of claim 13, further comprising:
a queue located in the first data center and instantiated on the cloud server;
wherein the second data representation of the second IOT device is a set of entries in the queue.

17. The IOT system of claim 13, further comprising:
a rules engine instantiated on the cloud server;
wherein a first instruction executed by an applications layer of the cloud server pulls information from the first IOT device or pushes commands to the first IOT device;
wherein a second instruction executed by the applications layer of the cloud server pulls information from the second IOT device or pushes a command to the second IOT device;
wherein the first instruction and the second instruction share an identical syntax; and
wherein the rules engine formulates the first instruction and the second instruction in accordance with a rule.

18. An internet of things (IOT) system comprising:
a cloud server located in a first data center;
a first IOT device located at a customer site, wherein the first IOT device communicates with the cloud server via the Internet;
a first data representation of the first IOT device administrated by the cloud server;
a virtual native server located in the first data center;
a second IOT device, wherein the second IOT device communicates with the cloud server via the Internet, a second cloud server, and the virtual native server;
a second data representation of the second IOT device administrated by the virtual native server; and
a first cloud adapter instantiated on the virtual native server, wherein the first cloud adapter enforces consistency between the second IOT device and the second data representation of the second IOT device;
wherein the cloud server includes stored instructions to do least one of the following actions: (i) directly issue every command the second IOT device can receive; and (ii) read every data entry collected by the second IOT device.

19. The IOT system of claim 18, further comprising:
a third IOT device, wherein the third IOT device communicates with the cloud server via the Internet, a second API, the virtual native server, and a third cloud server;
a third representation of the third IOT device administrated by the virtual native server;
a second cloud adapter instantiated on the virtual native server, wherein the second cloud adapter enforces consistency between the third IOT device and the third representation of the third IOT device; and
a cloud connector instantiated on the virtual native server;
wherein the cloud connector receives a common command from the cloud server, provides a first translated command to the first cloud adapter, and provides a second translated command to the second cloud adapter; and
wherein the first translated command and the second translated command are translated versions of the common command.

20. The IOT system of claim 19, further comprising:
an attribute path map for an attribute,
wherein the first and second cloud adapters are both required to enforce consistency with regards to the attribute;
wherein the attribute path map includes a first path for the attribute in a first data structure of the second cloud server;
wherein the attribute path map includes a second path for the attribute in a second data structure of the third cloud server;
wherein the attribute path map is a set of key value pairs stored in data on the virtual native server and administrated by the cloud connector; and
wherein the attribute is a key of the set of key value pairs.

21. The IOT system of claim 19, wherein:
the first cloud adapter and the second cloud adapter share a common core; and
the common core includes an authorization module, a write to device module; and a read from device module.

22. The IOT system of claim 21, wherein:
the first cloud adapter uses the authorization module and the second cloud server to federate the second IOT device; and
the second cloud adapter uses the authorization module and the third cloud server to federate the third IOT device.

23. The IOT system of claim 21, further comprising:
a database located in the first data center and administrated by the cloud server;
wherein the first data representation of the first IOT device is a first data structure in the database; and
wherein the second data representation of the second IOT device is a second data structure in the database.

24. The IOT system of claim 21, further comprising:
a queue located in the first data center and instantiated on the cloud server;
wherein the second data representation of the second IOT device is a set of entries in the queue; and
wherein the second cloud server is located in a second data center.

25. The IOT system of claim 21, further comprising:
a rules engine instantiated on the cloud server;
wherein a first instruction executed by an applications layer of the cloud server pulls information from the first IOT device or pushes commands to the first IOT device;
wherein a second instruction executed by the applications layer of the cloud server pulls information from the second IOT device or pushes a command to the second IOT device;
wherein the first instruction and the second instruction share an identical syntax; and
wherein the rules engine formulates the first instruction and the second instruction in accordance with a rule.
